(19) United States
(12) Patent Application Publication
(10) Pub. No.: US 2023/0047821 A1
(43) Pub. Date: Feb. 16, 2023

(54) Active Learning Event Models

(71) Applicant: STATS LLC, Chicago, IL (US)

(72) Inventors: Matthew Scott, Chicago, IL (US); Patrick Joseph Lucey, Chicago, IL (US)

(73) Assignee: STATS LLC, Chicago, IL (US)

(21) Appl. No.: 17/819,828

(22) Filed: Aug. 15, 2022

Related U.S. Application Data
(60) Provisional application No. 63/260,291, filed on Aug. 16, 2021.

(51) Int. Cl. G06N 20/00

(52) U.S. Cl. CPC G06N 20/00

(57) ABSTRACT

A computing system receives a training data set that includes a first subset of labeled events and a second subset of unlabeled events for an event type. The computing system generates an event model configured to detect the event type and classify the event type by actively training the event model. The computing system receives a target game file for a target game. The target game file includes at least tracking data corresponding to players in the target game. The computing system identifies a plurality of instances of the event type in the target game using the event model. The computing system classifies each instance of the plurality of instances of the event type using the event model. The computing system generates an updated event game file based on the target game file and the plurality of instances.

### CROSS-REFERENCE TO RELATED APPLICATIONS

This application claims priority to U.S. Provisional Application No. 63/260,291, filed Aug. 16, 2021, which is hereby incorporated by reference in its entirety.

### FIELD OF THE DISCLOSURE

The present disclosure generally relates to system and method for generating and deploying active learning event models.

### BACKGROUND

With the proliferation of data, sports teams, commentators, and fans alike are more interested in identifying and classifying events that occur throughout a game or across a season. Given the vast amount of data that exists for each event, manually filtering through this data to identify each instance of an event is an onerous task.

### SUMMARY

In some embodiments, a method is disclosed herein. A computing system receives a training data set. The training data set includes a first subset of labeled events and a second subset of unlabeled events for an event type. The computing system generates an event model configured to detect the event type and classify the event type by actively training the event model using the first subset of labeled events and the second subset of labeled events. The computing system receives a target game file for a target game. The target game file includes at least tracking data corresponding to players in the target game. The computing system identifies a plurality of instances of the event type in the target game using the event model. The computing system classifies each instance of the plurality of instances of the event type using the event model. The computing system generates an updated event game file based on the target game file and the plurality of instances.

In some embodiments, a non-transitory computer readable medium is disclosed herein. The non-transitory computer readable medium includes one or more sequences of instructions, which, when executed by a processor, causes a computing system to perform operations. The operations include receiving, by the computing system, a training data set. The training data set includes a first subset of labeled events and a second subset of unlabeled events for an event type. The operations further include generating, by the computing system, an event model configured to detect the event type and classify the event type by actively training the event model using the first subset of labeled events and the second subset of labeled events. The operations further include receiving, by the computing system, a target game file for a target game. The target game file includes at least tracking data corresponding to players in the target game. The operations further include identifying, by the computing system, a plurality of instances of the event type in the target game using the event model. The operations further include classifying, by the computing system, each instance of the plurality of instances of the event type using the event model. The operations further include generating, by the computing system, an updated event game file based on the target game file and the plurality of instances.

In some embodiments, a system is disclosed herein. The system includes a processor and a memory. The memory has programming instructions stored thereon, which, when executed by the processor, causes the system to perform operations. The operations include receiving a training data set. The training data set includes a first subset of labeled events and a second subset of unlabeled events for an event type. The operations further include generating an event model configured to detect the event type and classify the event type by actively training the event model using the first subset of labeled events and the second subset of labeled events. The operations further include receiving a target game file for a target game. The target game file includes at least tracking data corresponding to players in the target game. The operations further include identifying a plurality of instances of the event type in the target game using the event model. The operations further include classifying each instance of the plurality of instances of the event type using the event model. The operations further include generating an updated event game file based on the target game file and the plurality of instances.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 illustrates an exemplary graphical user interface for training an event model, according to example embodiments.

FIG. 3 illustrates an exemplary graphical user interface for training an event model, according to example embodiments.

FIG. 4 illustrates an exemplary graphical user interface for training an event model, according to example embodiments.

FIG. 5 is a flow diagram illustrating a method of generating an event model, according to example embodiments.

FIG. 6 is a flow diagram illustrating a method of classifying events within a game, according to example embodiments.

FIG. 7A is a block diagram illustrating a computing device, according to example embodiments.

FIG. 7B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Conventionally, to perform event detection within a game, a computing system typically requires clean tracking data for a model to be able to accurately identify an event. Such processing of cleaning the tracking data is time-consuming and if a human operator fails to adequately clean the data, the output from the model may be inaccurate.

To improve upon conventional techniques, the present system employs an active learning approach that is able to handle a variable number of players (i.e., missing players), which lends itself to broadcast tracking data or live data, which are inherently noisy forms of data. The present system does not require any cleaning of the data before input into the system. In this manner, users are able to develop event specific models with each model trained to identify and classify a certain event type.

While the below discussion is with respect to applying active learning techniques in the field of basketball, those skilled in the art understand that these techniques may be applied to any sport, such as, but not limited to, football, soccer, tennis, rugby, hockey, and the like.

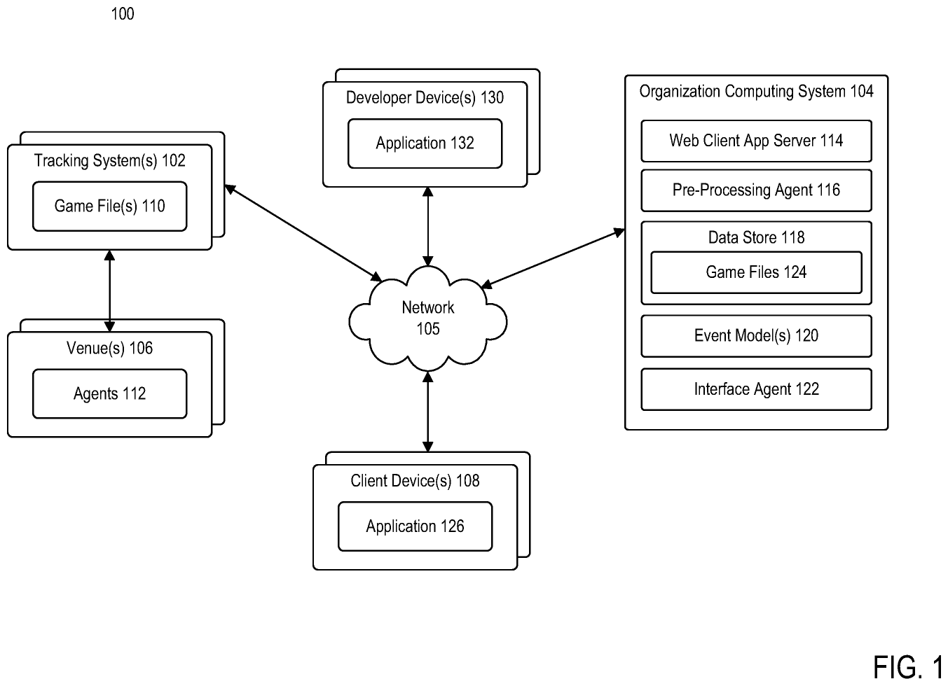

FIG. 1 is a block diagram illustrating a computing environment 100, according to example embodiments. Computing environment 100 may include tracking system 102, organization computing system 104, one or more client devices 108, and one or more developer devices 130 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™ ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106. For example, venue 106 may be configured to host a sporting event that includes one or more agents 112. Tracking system 102 may be configured to capture the motions of all agents (i.e., players) on the playing surface, as well as one or more other objects of relevance (e.g., ball, referees, etc.). In some embodiments, tracking system 102 may be an optically-based system using, for example, a plurality of fixed cameras. For example, a system of six stationary, calibrated cameras, which project the three-dimensional locations of players and the ball onto a two-dimensional overhead view of the court may be used. In another example, a mix of stationary and non-stationary cameras may be used to capture motions of all agents on the playing surface as well as one or more objects or relevance. As those skilled in the art recognize, utilization of such tracking system (e.g., tracking system 102) may result in many different camera views of the court (e.g., high sideline view, free-throw line view, huddle view, face-off view, end zone view, etc.). In some embodiments, tracking system 102 may be used for a broadcast feed of a given match. In such embodiments, each frame of the broadcast feed may be stored in a game file 110.

In some embodiments, game file 110 may further be augmented with other event information corresponding to event data, such as, but not limited to, game event information (pass, made shot, turnover, etc.) and context information (current score, time remaining, etc.).

Tracking system 102 may be configured to communicate with organization computing system 104 via network 105. Organization computing system 104 may be configured to manage and analyze the data captured by tracking system 102. Organization computing system 104 may include at least a web client application server 114, a pre-processing agent 116, a data store 118, a plurality of event models 120, and an interface agent 122. Each of pre-processing agent and interface agent 122 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Data store 118 may be configured to store one or more game files 124. Each game file 124 may include video data of a given match. For example, the video data may correspond to a plurality of video frames captured by tracking system 102. In some embodiments, the video data may correspond to broadcast data of a given match, in which case, the video data may correspond to a plurality of video frames of the broadcast feed of a given match. Generally, such information may be referred to herein as “tracking data.”

Pre-processing agent 116 may be configured to process data retrieved from data store 118. For example, pre-processing agent 116 may be configured to generate game files 124 stored in data store 118. For example, pre-processing agent 116 may be configured to generate a game file 124 based on data captured by tracking system 102. In some embodiments, pre-processing agent 116 may further be configured to store tracking data associated with each game in a respective game file 124. Tracking data may refer to the (x,y) coordinates of all players and balls on the playing surface during the game. In some embodiments, pre-processing agent 116 may receive tracking data directly from tracking system 102. In some embodiments, pre-processing agent 116 may derive tracking data from the broadcast feed of the game.

Event models 120 may be representative of a suite of active learning models trained to identify certain events in a game. For example, event models 120 may be representative of a suite of active learning models trained to identify a plurality of event types in a basketball game. Exemplary event types may include, but are not limited to man-to-man defense, 3-2 zone defense, 2-3 zone defense, 1-3-1 zone, a ball screen, a drive, and the like. Each event model 120 of the plurality of event models 120 may be trained to identify a specific event type. For example, plurality of event models 120 may include a first model trained to identify the defensive arrangement of a team (e.g., zone defense, man defense, 2-3 zone, 1-3-1 zone, 3-2 zone, etc.) and a second model trained to identify when a ball screen occurs.

In some embodiments, each event model 120 may be a regression-based model. To train each event model 120 for its respective task, each event model 120 may undergo an active learning process. Such active learning process may include a user labeling data used for training. The user may label, for example, team activities and player specific events (both on and off ball).

To facilitate the active learning process, interface agent 122 may generate an interface that allows a user (e.g., developer device 130) to label plays for training each event model 120. To generate the interface, interface agent 122 may generate graphical representations of a plurality of segments of a plurality of games. A user may analyze each graphical representation and label the corresponding segment. For example, for an event model 120 trained to identify whether a screen occurred, a user may label each graphical representation with one or more of an indication of whether a screen occurred, how the ball handler's defender defended the screen (e.g., went over or under the screen), how the screener's defender defended the screen (e.g., soft, fight over, etc.), and the screener's role (e.g., roll, flare out, etc.). In another example, for event model 120 trained to identify whether a drive occurred, a user may label each graphical representation with an indication of whether a drive occurred (e.g., yes or no). In another example, for event model 120 to identify the defensive formation of the defense, a user may label each graphical representation with an indication of the defensive type (e.g., zone or man to man) and a defensive group (e.g., for a zone defensive type, whether it is a 3-2 zone, 1-3-1 zone, 2-3 zone, etc.).

To determine whether an event occurred, an operator may define what is meant by a certain defensive formation, screen, drive, and the like. For example, a screen may be defined from the potential screener's perspective. To cut down the number of screens viewed, the screens are ball screens that occur in the front court. For a screen to be deemed to occur, the potential screener may have to be within a threshold distance (e.g., 12 feet) from the ball handler at some point during the potential screen. The screen event may begin and/or end when the screener moves a threshold amount (>10 feet) or the ball handler's touch ends, whichever happens first. Further, potential screener and ball handler may be defined using a broad rule-based system. Potential defenders may be defined using smoothed influence scores over the frames just before and just after the start of the potential screen.

Using another example, a drive may be an event that occurs during a half court opportunity. A drive may be defined as an event that starts between 10 and 30 feet, for example, from the basket and that ends within 20 feet of the basket. The ball handler may travel at least five feet for the event to be considered a drive. The drive may start when the ball handler makes a movement towards the basket and may end when that movement stops. Although the above definition may refer to specific distances, those skilled in the art understand that different distances may be used.

Each event model 120 may include features for its respective task. For example, a screen event model may have features that include various metrics for four potential players of interest—a ball handler, a screener, a ball handler defender, and a screener defender—at four points in time—start of screen, end of screen, time of screen itself (e.g., frame where screener/ball handler are closest to each other), and end of ball handler touch. The features at each of these points in time may include (x,y) coordinates, distance from the basket, and influence scores for the four potential players.

In another example, a drive event model may have features that include start location, end location, basket distance, length of potential drive, total distance travelled, time between start of touch and start of drive, and the like.

In another example, a defensive type event model may have features that include average (x,y) positions for all five defenders over the entire chance, average basket distance for all five defenders, average distance from that average location, i.e., how much the player is moving throughout the chance, length of time in the front court, average influence scores for each offensive/defensive player combination, i.e., player orderings determined by average basket distances, average distance between each offensive/defensive player combination, a count of drives, isolations, post ups, ball screens, closeouts, dribble handoffs, and off ball screens during the chance, a total number of switches on ball screens/off ball screens, and the like.

Once an initial training data set is labeled for training of each respective event model 120, event model 120 may be provided with the initial training data set for an initial training process followed by an unlabeled data set for further training. Interface agent 122 may generate updated interfaces for end users based on the unlabeled data set. For example, for each play or segment in the unlabeled data set, interface agent 122 may generate a graphical representation of that play or segment, as well as output from an associated event model 120. The output from the associated event model 120 may correspond to how event model 120 classified that segment. For example, referring back to a screen event, the user may be provided with an interface that includes output in the form of whether a screen occurred, the ball handler defender coverage, the screener defender coverage, the screener role, and the like. A user may then either verify that event model 120 made the correct classifications, based on the graphical representation, or provide that it was a false positive. Further, the user can provide the system with the correct classification if any of the classifications were incorrect.

In this manner, each event model 120 may undergo an active learning process to achieve its intended functionality.

Developer device 130 may be in communication with organization computing system 104 via network 105. Developer device 130 may be operated by a developer associated with organization computing system 104. Developer device 130 may be representative of a mobile device, a tablet, a desktop computer, or any computing system having the capabilities described herein.

Developer device 130 may include at least application 132. Application 132 may be representative of a web browser that allows access to a website or a stand-alone application. Developer device 130 may access application 132 to access one or more functionalities of organization computing system 104. Developer device 130 may communicate over network 105 to request a webpage, for example, from web client application server 114 of organization computing system 104. For example, developer device 130 may be configured to execute application 132 to access actively train event models 120. Via application 132, a user may be able to label initial training data sets for training each event model 120, as well as review output from a respective event model 120 when it is trained on unlabeled data. The content that is displayed to developer device 130 may be transmitted from web client application server 114 to developer device 130, and subsequently processed by application 132 for display through a graphical user interface (GUI) of developer device 130.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 126. Application 126 may be representative of a web browser that allows access to a website or a stand-alone application. Client device 108 may access application 126 to access one or more functionalities of organization computing system 104. Client device 108 may communicate over network 105 to request a webpage, for example, from web client application server 114 of organization computing system 104. For example, client device 108 may be configured to execute application 126 to access functionality of event models 120. Via application 126, a user may be able to input a game file for event detection using event models 120. The content that is displayed to client device 108 may be transmitted from web client application server 114 to client device 108, and subsequently processed by application 126 for display through a graphical user interface (GUI) of client device 108.

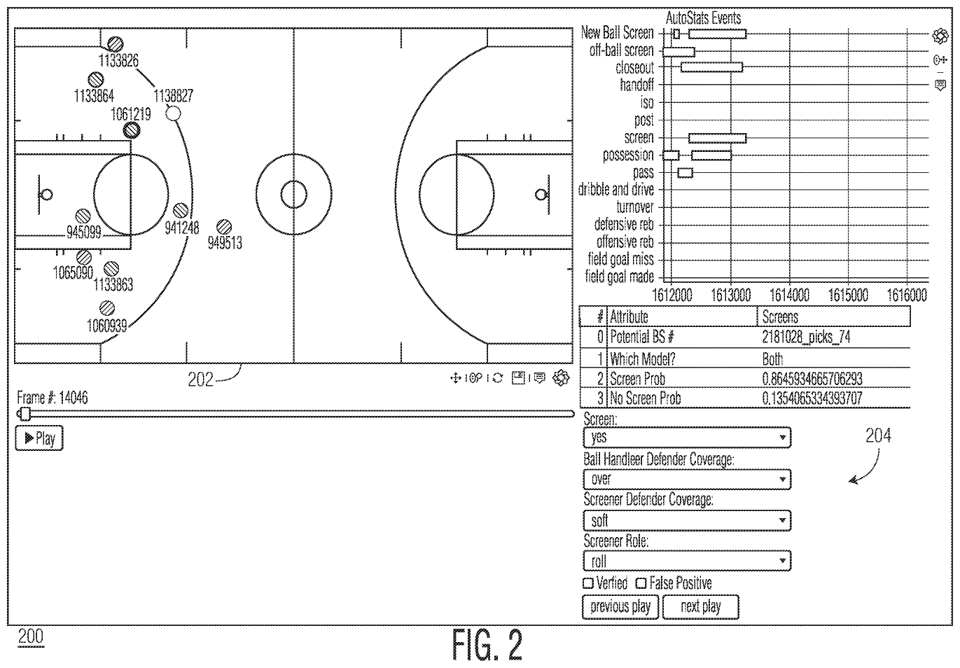

FIG. 2 illustrates an exemplary graphical user interface (GUI) 200, according to example embodiments. GUI 200 may correspond to an interface generated by interface agent 122 for active training of an event model 120.

As shown, GUI 200 may include a graphical representation 202. Graphical representation 202 may be representative of a video of a segment of a game that event model 120 analyzed while learning to identify ball screens. Via graphical representation 202, a developer may be able to review whether a ball screen occurred in this segment and, if a ball screen did occur, certain attributes or features of the ball screen. GUI 200 may be generated by interface agent 122 and provided to developer device 130 via application 132 executing thereon.

GUI 200 may further include a classification section 204. Classification section 204 may provide a developer with a set of outputs from event model 120 for the segment of the game depicted in graphical representation 202. For example, as shown, classification section 204 includes a first classification regarding whether a screen occurred (e.g., yes or no), a second classification regarding the ball handler defender coverage (e.g., over, under, switch, blitz), a third classification regarding the screener defender coverage (e.g., soft, up to touch, show, switch, blitz), and a fourth classification regarding the screener's role (e.g., roll, pop). If event model 120 successfully classifies the event in the segment, then a developer can verify the output and move on to the next play. If, however, event model 120 fails to successfully classify the event in the segment, then a user may correct the incorrect output (e.g., one of the first, second, third, or fourth classifications) and note that it was a false positive. In this manner, a developer may actively train event model 120 to detect screens.

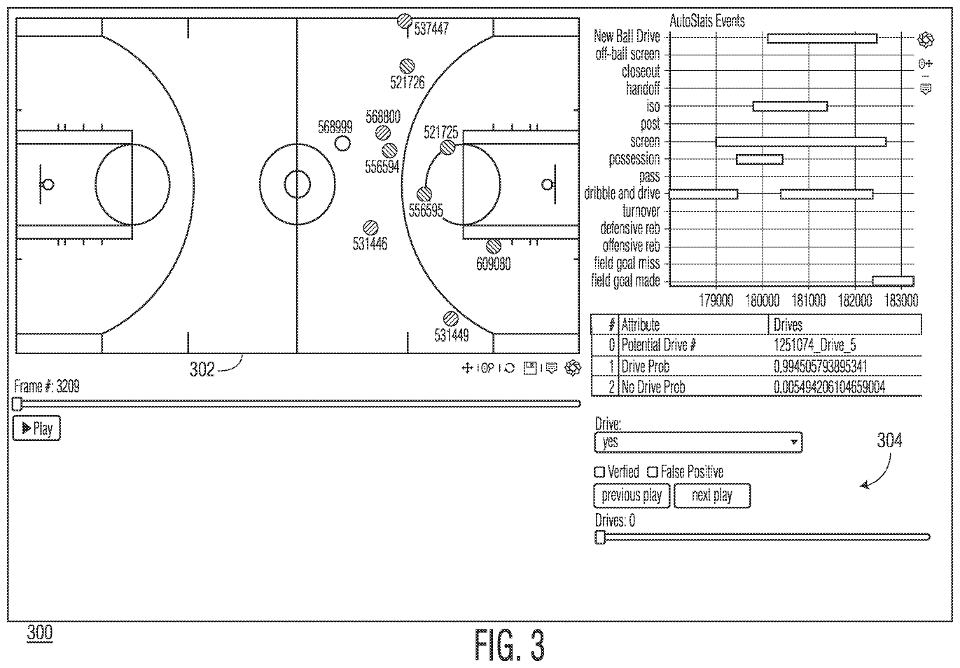

FIG. 3 illustrates an exemplary graphical user interface (GUI) 300, according to example embodiments. GUI 300 may correspond to an interface generated by interface agent 122 for active training of an event model 120.

As shown, GUI 300 may include a graphical representation 302. Graphical representation 302 may be representative of a video of a segment of a game that event model 120 analyzed while learning to identify drives. Via graphical representation 302, a developer may be able to review whether a drive occurred in this segment and, if a drive did occur, certain attributes or features of the drive. GUI 300 may be generated by interface agent 122 and provided to developer device 130 via application 132 executing thereon.

GUI 300 may further include a classification section 304. Classification section 304 may provide a developer with a set of outputs from event model 120 for the segment of the game depicted in graphical representation 302. For example, as shown, classification section 304 includes a first classification regarding whether a drive occurred (e.g., yes or no). If event model 120 successfully classifies the event in the segment, then a developer can verify the output and move on to the next play. If, however, event model 120 fails to successfully classify the event in the segment, then a user may correct the incorrect output (e.g., the first classification) and note that it was a false positive. In this manner, a developer may actively train event model 120 to detect screens.

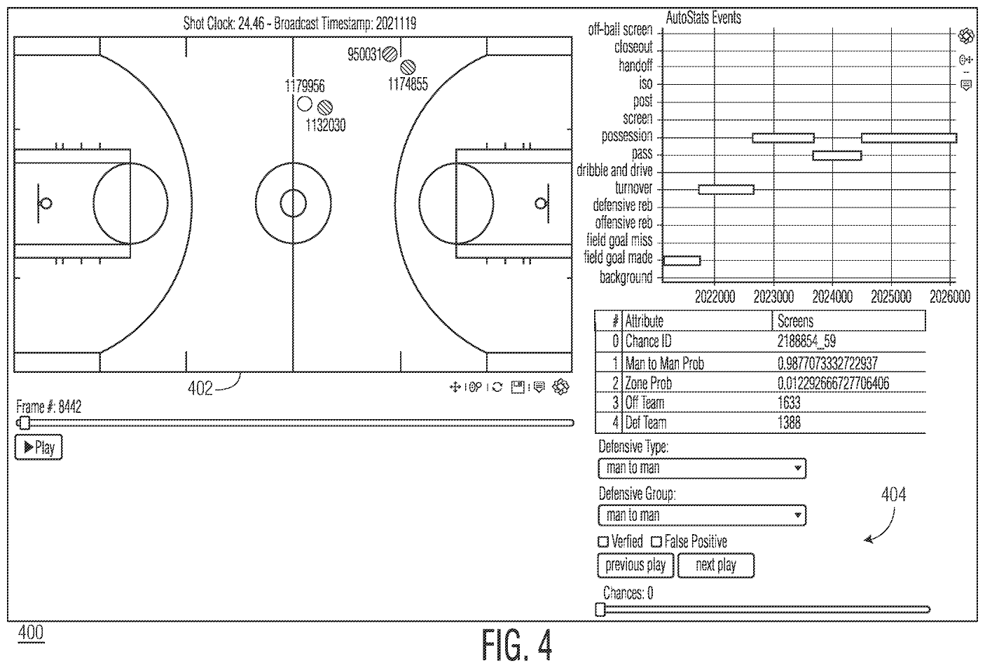

FIG. 4 illustrates an exemplary graphical user interface (GUI) 400, according to example embodiments. GUI 400 may correspond to an interface generated by interface agent 122 for active training of an event model 120.

As shown, GUI 400 may include a graphical representation 402. Graphical representation 402 may be representative of a video of a segment of a game that event model 120 analyzed while learning to identify defensive types. Via graphical representation 402, a developer may be able to review a defensive type and a defensive group within the identified defensive type. GUI 400 may be generated by interface agent 122 and provided to developer device 130 via application 132 executing thereon.

GUI 400 may further include a classification section 404. Classification section 404 may provide a developer with a set of outputs from event model 120 for the segment of the game depicted in graphical representation 402. For example, as shown, classification section 404 includes a first classification regarding the defensive type (e.g., man to man, 2-3 zone, 1-3-1 zone, matchup zone, miscellaneous zone, junk, 3-2 zone, etc.) and the defensive grouping (e.g., man-to-man or zone). If event model 120 successfully classifies the defensive formation in the segment, then a developer can verify the output and move on to the next play. If, however, event model 120 fails to successfully classify the defensive formation in the segment, then a user may correct the incorrect output (e.g., one of the first or second classifications) and note that it was a false positive. In this manner, a developer may actively train event model 120 to detect defensive types.

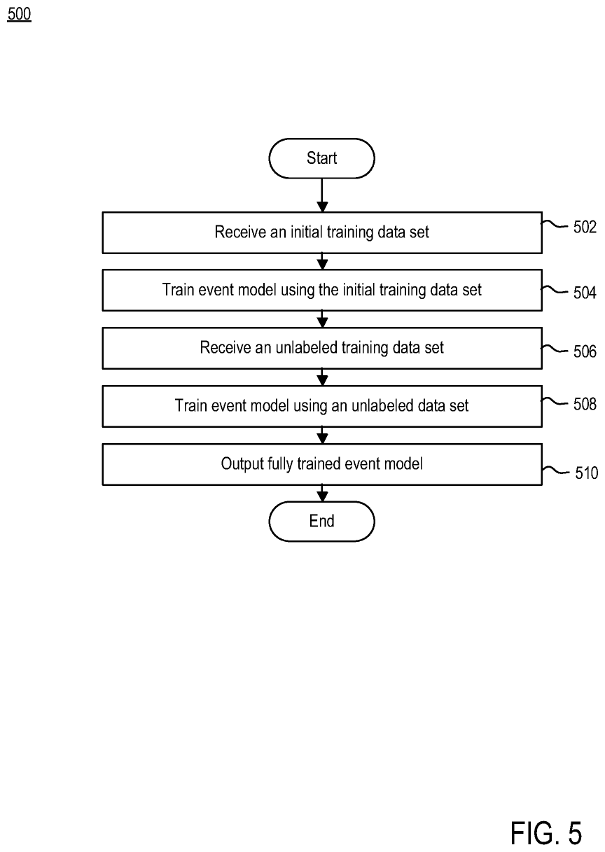

FIG. 5 is a flow diagram illustrating a method 500 of training an event model 120, according to example embodiments. While the below discussion may be in conjunction with an event model 120 dedicated to identifying and classifying screens, those skilled in the art understand that the present techniques can be applied to training an event model 120 to detect any assortment of events. Method 500 may begin at step 502.

At step 502, organization computing system 104 may receive an initial training data set. The initial training data set may include a plurality of event segments. Each event segment of the plurality of event segments may include labeled information. Exemplary labeled information may include, for example, whether a screen occurred, the type of ball handler defender coverage, the type of screener defender coverage, and the screener role. In some embodiments, organization computing system 104 may receive the initial training data set by generating various interfaces for a developer to label segments of games. In some embodiments, organization computing system 104 may receive a pre-labeled set of segments for training event model 120.

At step 504, organization computing system 104 may train event model 120 using the initial training data set. For example, using the initial training data set, event model 120 may learn to identify whether a screen occurred in a segment, the type of ball handler defender coverage, the type of screener defender coverage, and the screener role. In some embodiments, event model 120 may be trained to generate features that include various metrics for four potential players of interest (e.g., ball handler, screener, ball handler defender, screener defender) at four points in time (e.g., start of screen, end of screen, time of the screen itself, and end of ball handler touch). The features at each of these points in time may include one or more of (x,y) coordinates of the four players of interest, distance from the basket of each of the four players of interest, and influence scores for those combination of players.

At step 506, organization computing system 104 receive an unlabeled data set for training event model 120. For example, following training of event model 120 using the initial training data set that was labeled, a developer may provide event model 120 with an unlabeled data set to determine the accuracy of event model 120. In some embodiments, the unlabeled data set may include a plurality of segments from a plurality of events.

At step 508, organization computing system 104 may train event model 120 using the unlabeled data set. For example, organization computing system 104 may provide the unlabeled data set to event model 120 for classification. Following classification of a segment, interface agent 122 may generate an interface (e.g., such as GUI 200) that includes a graphical representation of the segment and output classifications generated by event model 120. A developer may review the graphical representation and either verify that event model 120 correctly classified the event or provide that event model 120 incorrectly classified the event. In those embodiments in which event model 120 improperly or incorrectly classified the event, the developer may correct the incorrect classification to adjust various weights associated with event model 120. In this manner, event model 120 may undergo an active learning process to identify and classify screens in an event.

At step 510, organization computing system 104 may output a fully trained event model 120 configured to identify and classify screens within an event.

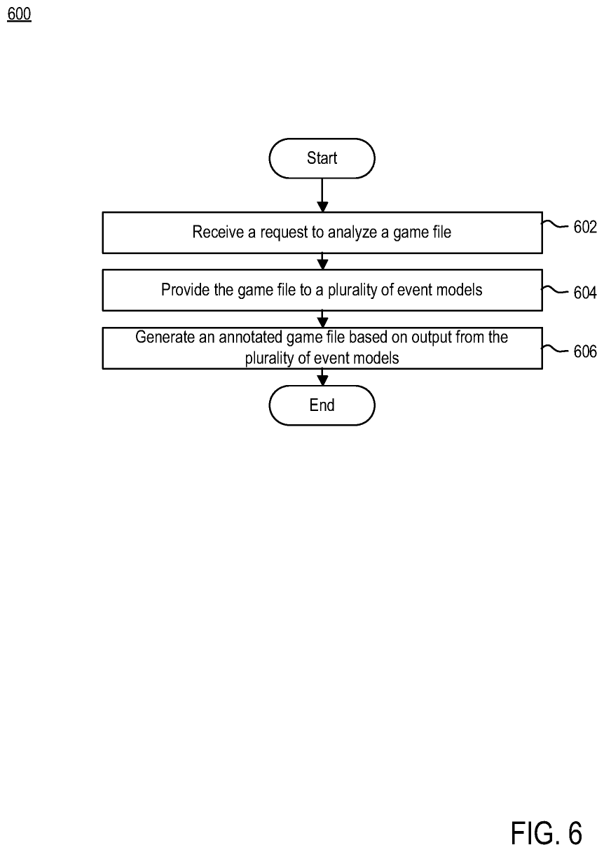

FIG. 6 is a flow diagram illustrating a method 600 of classifying events within a game, according to example embodiments. Method 600 may begin at step 602.

At step 602, organization computing system 104 may receive a request to analyze a game file from a user. For example, a user may utilize application 126 on client device 108 to select or upload a game file for analysis. In some embodiments, the game file may include broadcast data for the game. In some embodiments, the game file may include event data for the game. In some embodiments, the game file may include tracking data for the game.

At step 604, organization computing system 104 may provide the game file to a suite of event models 120 for analysis. For example, organization computing system 104 may input the game file to a plurality of event models 120, with each event model 120 trained to identify and classify a certain type of event. Continuing with the above examples, the plurality of event models 120 may include a first event model trained to identify and classify screens, a second event model trained to identify and classify drives, and a third event model trained to identify and classify defensive formations.

At step 606, organization computing system 104 may generate an annotated game file based on the analysis. For example, pre-processing agent 116 may be configured to annotate the game file based on events and classifications generated by the plurality of event models 120. In this manner, an end user, via client device 108, can search for specific events or event classifications in a single game file 124 or across game files 124.

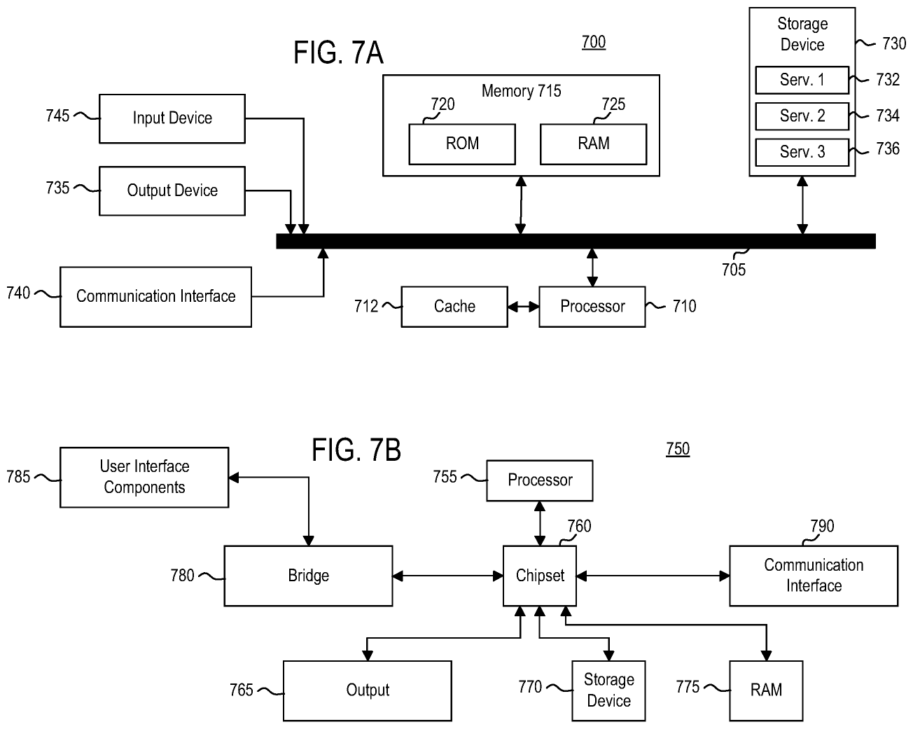

FIG. 7A illustrates an architecture of computing system 700, according to example embodiments. System 700 may be representative of at least a portion of organization computing system 104. One or more components of system 700 may be in electrical communication with each other using a bus 705. System 700 may include a processing unit (CPU or processor) 710 and a system bus 705 that couples various system components including the system memory 715, such as read only memory (ROM) 720 and random access memory (RAM) 725, to processor 710. System 700 may include a cache of high-speed memory connected directly with, in close proximity to, or integrated as part of processor 710. System 700 may copy data from memory 715 and/or storage device 730 to cache 712 for quick access by processor 710. In this way, cache 712 may provide a performance boost that avoids processor 710 delays while waiting for data. These and other modules may control or be configured to control processor 710 to perform various actions. Other system memory 715 may be available for use as well. Memory 715 may include multiple different types of memory with different performance characteristics. Processor 710 may include any general purpose processor and a hardware module or software module, such as service 1 732, service 2 734, and service 3 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction with the computing system 700, an input device 745 may represent any number of input mechanisms, such as a microphone for speech, a touch-sensitive screen for gesture or graphical input, keyboard, mouse, motion input, speech and so forth. An output device 735 (e.g., display) may also be one or more of a number of output mechanisms known to those of skill in the art. In some instances, multimodal systems may enable a user to provide multiple types of input to communicate with computing system 700. Communications interface 740 may generally govern and manage the user input and system output. There is no restriction on operating on any particular hardware arrangement and therefore the basic features here may easily be substituted for improved hardware or firmware arrangements as they are developed.

Storage device 730 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 725, read only memory (ROM) 720, and hybrids thereof.

Storage device 730 may include services 732, 734, and 736 for controlling the processor 710. Other hardware or software modules are contemplated. Storage device 730 may be connected to system bus 705. In one aspect, a hardware module that performs a particular function may include the software component stored in a computer-readable medium in connection with the necessary hardware components, such as processor 710, bus 705, output device 735, and so forth, to carry out the function.

FIG. 7B illustrates a computer system 750 having a chipset architecture that may represent at least a portion of organization computing system 104. Computer system 750 may be an example of computer hardware, software, and firmware that may be used to implement the disclosed technology. System 750 may include a processor 755, representative of any number of physically and/or logically distinct resources capable of executing software, firmware, and hardware configured to perform identified computations. Processor 755 may communicate with a chipset 760 that may control input to and output from processor 755. In this example, chipset 760 outputs information to output 765, such as a display, and may read and write information to storage device 770, which may include magnetic media, and solid-state media, for example. Chipset 760 may also read data from and write data to RAM 775. A bridge 780 for interfacing with a variety of user interface components 785 may be provided for interfacing with chipset 760. Such user interface components 785 may include a keyboard, a microphone, touch detection and processing circuitry, a pointing device, such as a mouse, and so on. In general, inputs to system 750 may come from any of a variety of sources, machine generated and/or human generated.

Chipset 760 may also interface with one or more communication interfaces 790 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 755 analyzing data stored in storage device 770 or RAM 775. Further, the machine may receive inputs from a user through user interface components 785 and execute appropriate functions, such as browsing functions by interpreting these inputs using processor 755.

It may be appreciated that example systems 700 and 750 may have more than one processor 710 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method comprising:
receiving, by a computing system, a training data set comprising a first subset of labeled events and a second subset of unlabeled events for an event type;
generating, by the computing system, an event model configured to detect the event type and classify the event type by actively training the event model using the first subset of labeled events and the second subset of labeled events;
receiving, by the computing system, a target game file for a target game, wherein the target game file includes at least tracking data corresponding to players in the target game;
identifying, by the computing system, a plurality of instances of the event type in the target game using the event model;
classifying, by the computing system, each instance of the plurality of instances of the event type using the event model; and
generating, by the computing system, an updated event game file based on the target game file and the plurality of instances.

2. The method of claim 1, wherein generating, by the computing system, the event model configured to detect the event type and classify the event type by actively training the event model using the first subset of labeled events and the second subset of labeled events comprises:
training the event model by first inputting the first subset of labeled events.

3. The method of claim 2, further comprising:
training the event model by inputting the second subset of labeled events following the first subset of labeled events.

4. The method of claim 3, further comprising:
presenting to a developer a representation of a segment of a game in the second subset of labeled events and an output from the event model for the segment of the game; and
receiving, from the developer, an indication that the output from the event model was correct.

5. The method of claim 3, further comprising:
presenting to a developer a representation of a segment of a game in the second subset of labeled events and an output from the event model for the segment of the game; and
receiving, from the developer, an indication that the output from the event model was incorrect, wherein the indication comprises a correction to the output from the event model.

6. The method of claim 5, further comprising:
re-training the event model using the correction to the output.

7. The method of claim 1, further comprising:
receiving, by the computing system, a second training data set comprising a third subset of labeled events and a fourth subset of unlabeled events for a second event type; and
generating, by the computing system, a second event model configured to detect the second event type and classify the second event type by actively training the second event model using the third subset of labeled events and the fourth subset of labeled events.

8. A non-transitory computer readable medium comprising one or more sequences of instructions, which, when executed by a processor, causes a computing system to perform operations comprising:
receiving, by the computing system, a training data set comprising a first subset of labeled events and a second subset of unlabeled events for an event type;
generating, by the computing system, an event model configured to detect the event type and classify the event type by actively training the event model using the first subset of labeled events and the second subset of labeled events;
receiving, by the computing system, a target game file for a target game, wherein the target game file includes at least tracking data corresponding to players in the target game;
identifying, by the computing system, a plurality of instances of the event type in the target game using the event model;
classifying, by the computing system, each instance of the plurality of instances of the event type using the event model; and
generating, by the computing system, an updated event game file based on the target game file and the plurality of instances.

9. The non-transitory computer readable medium of claim 8, wherein generating, by the computing system, the event model configured to detect the event type and classify the event type by actively training the event model using the first subset of labeled events and the second subset of labeled events comprises:
training the event model by first inputting the first subset of labeled events.

10. The non-transitory computer readable medium of claim 9, further comprising:
training the event model by inputting the second subset of labeled events following the first subset of labeled events.

11. The non-transitory computer readable medium of claim 10, further comprising:
presenting to a developer a representation of a segment of a game in the second subset of labeled events and an output from the event model for the segment of the game; and
receiving, from the developer, an indication that the output from the event model was correct.

12. The non-transitory computer readable medium of claim 10, further comprising:
presenting to a developer a representation of a segment of a game in the second subset of labeled events and an output from the event model for the segment of the game; and
receiving, from the developer, an indication that the output from the event model was incorrect, wherein the indication comprises a correction to the output from the event model.

13. The non-transitory computer readable medium of claim 12, further comprising:
re-training the event model using the correction to the output.

14. The non-transitory computer readable medium of claim 8, further comprising:
receiving, by the computing system, a second training data set comprising a third subset of labeled events and a fourth subset of unlabeled events for a second event type; and
generating, by the computing system, a second event model configured to detect the second event type and classify the second event type by actively training the second event model using the third subset of labeled events and the fourth subset of labeled events.

15. A system comprising:
a processor; and
a memory having programming instructions stored thereon, which, when executed by the processor, causes the system to perform operations comprising:
receiving a training data set comprising a first subset of labeled events and a second subset of unlabeled events for an event type;
generating an event model configured to detect the event type and classify the event type by actively training the event model using the first subset of labeled events and the second subset of labeled events;
receiving a target game file for a target game, wherein the target game file includes at least tracking data corresponding to players in the target game;
identifying a plurality of instances of the event type in the target game using the event model;
classifying each instance of the plurality of instances of the event type using the event model; and
generating an updated event game file based on the target game file and the plurality of instances.

16. The system of claim 15, wherein generating the event model configured to detect the event type and classify the event type by actively training the event model using the first subset of labeled events and the second subset of labeled events comprises:
training the event model by first inputting the first subset of labeled events.

17. The system of claim 16, further comprising:
training the event model by inputting the second subset of labeled events following the first subset of labeled events.

18. The system of claim 17, further comprising:
presenting to a developer a representation of a segment of a game in the second subset of labeled events and an output from the event model for the segment of the game; and
receiving, from the developer, an indication that the output from the event model was correct.

19. The system of claim 17, further comprising:
presenting to a developer a representation of a segment of a game in the second subset of labeled events and an output from the event model for the segment of the game; and
receiving, from the developer, an indication that the output from the event model was incorrect, wherein the indication comprises a correction to the output from the event model.

20. The system of claim 15, wherein the operations further comprise:
receiving a second training data set comprising a third subset of labeled events and a fourth subset of unlabeled events for a second event type; and
generating a second event model configured to detect the second event type and classify the second event type by actively training the second event model using the third subset of labeled events and the fourth subset of labeled events.
